(19) United States
(12) Patent Application Publication
(10) Pub. No.: US 2012/0237186 A1
(43) Pub. Date: Sep. 20, 2012

(54) MOVING IMAGE GENERATING METHOD, MOVING IMAGE GENERATING APPARATUS, AND STORAGE MEDIUM

(75) Inventors: Tetsuji MAKINO, Tokyo (JP); Mitsuyasu Nakajima, Tokyo (JP); Masayuki Hirohama, Tokyo (JP); Akira Hamada, Sagamihara-shi (JP); Yasushi Maeno, Tokyo (JP); Satoru Kakegawa, Tokyo (JP); Katsunori Ishii, Tokyo (JP); Yoshihiro Teshima, Tokyo (JP); Masatoshi Watanuki, Sagamihara-shi (JP); Hyuta Tanaka, Tokyo (JP); Michihiro Nihei, Tokyo (JP); Masaaki Sasaki, Tokyo (JP); Shinichi Matsui, Tokyo (JP)

(73) Assignee: Casio Computer Co., Ltd., Tokyo (JP)

(21) Appl. No.: 13/483,343

(22) Filed: May 30, 2012

(30) Foreign Application Priority Data
Mar. 6, 2011 (JP) 2011-125663

(51) Int. Cl. H04N 5/93

(52) U.S. Cl. 386/282; 386/278; 386/E05.028

(57) ABSTRACT

A moving image generating method, a moving image generating apparatus and a storage medium for generating a moving image from a still image. According to one application, a moving image generating method uses a moving image generating apparatus which stores in advance a plurality of pieces of movement information showing movements of a plurality of movable points. The method includes, an obtaining step which obtains a still image; a setting step which sets a plurality of movement control points in the still image; a frame image generating step which moves the plurality of control points based on movements of movement information and deforms the still image to generate a plurality of frame images; and a moving image generating step which generates a moving image from a plurality of frames.

### BACKGROUND OF THE INVENTION

1. Field of the Invention

The present invention relates to a moving image generating method, a moving image generating apparatus and a storage medium for generating a moving image from a still image.

2. Description of the Related Art

Conventionally, there is known a technique to move a still image by setting control points in a desired position of the still image and specifying a desired movement to the control point where movement is desired (Japanese Unexamined Patent Application Publication No. 2007-323293).

However, according to the above document, movement needs to be specified for each control point. Therefore, there is a problem that the work is troublesome and it is difficult to recreate movement desired by the user.

### SUMMARY OF THE INVENTION

The present invention has been made in consideration of the above situation, and one of the main objects is to provide a moving image generating method, a moving image generating apparatus and a storage medium to easily generate a moving image with movement desired by the user.

In order to achieve any one of the above advantages, according to an aspect of the present invention, there is provided a moving image generating method which uses a moving image generating apparatus which stores in advance a plurality of pieces of movement information showing movements of a plurality of movable points in a predetermined space, the method comprising:

an obtaining step which obtains a still image;

a setting step which sets a plurality of movement control points in each position corresponding to the plurality of movable points in the still image obtained in the obtaining step;

a frame image generating step which moves the plurality of control points based on movements of the plurality of movable points of one piece of movement information specified by a user from among the plurality of pieces of movement information and deforms the still image according to the movements of the control points to generate a plurality of frame images; and

a moving image generating step which generates a moving image from a plurality of frames generated in the frame image generating step.

According to another aspect of the present invention, there is provided a moving image generating apparatus comprising:

a storage section which stores in advance a plurality of pieces of movement information showing movements of a plurality of movable points in a predetermined space;

an obtaining section which obtains a still image;

a setting section which sets a plurality of movement control points in each position corresponding to the plurality of movable points in the still image obtained by the obtaining section;

a frame image generating section which moves the plurality of control points based on movements of the plurality of movable points of one piece of movement information specified by a user from among the plurality of pieces of movement information and deforms the still image according to the movements of the control points to generate a plurality of frame images; and

a moving image generating section which generates a moving image from a plurality of frames generated by the frame image generating section.

According to another aspect of the present invention, there is provided a non-transitory computer-readable storage medium having a program stored thereon for controlling a computer of a moving image generating apparatus including a storage section which stores in advance a plurality of pieces of movement information showing movements of a plurality of movable points in a predetermined space, wherein the program controls the computer to function as:

an obtaining section which obtains a still image;

a setting section which sets a plurality of movement control points in each position corresponding to the plurality of movable points in the still image obtained by the obtaining section;

a frame image generating section which moves the plurality of control points based on movements of the plurality of movable points of one piece of movement information specified by a user from among the plurality of pieces of movement information and deforms the still image according to the movements of the control points to generate a plurality of frame images; and

a moving image generating section which generates a moving image from a plurality of frames generated by the frame image generating section.

### BRIEF DESCRIPTION OF THE DRAWINGS

The present invention and the above-described objects, features and advantages thereof will become more fully understood from the following detailed description with the accompanying drawings and wherein;

FIG. 1 is a block diagram showing a schematic configuration of a moving image generating system of an embodiment employing the present invention;

FIG. 2 is a block diagram showing a schematic configuration of a user terminal composing the moving image generating system;

FIG. 3 is a block diagram showing a schematic configuration of a server composing the moving image generating system;

FIG. 4 is a flowchart showing an example of an operation of moving image generating processing of the moving image generating system;

FIG. 5 is a flowchart showing a continuation of the moving image generating processing shown in FIG. 4;

FIG. 6A to FIG. 6C are diagrams schematically showing an example of an image of the moving image generating processing shown in FIG. 4;

FIG. 7A to FIG. 7C are diagrams describing the moving image generating processing shown in FIG. 4; and

FIG. 8A and FIG. 8B are diagrams describing the moving image generating processing shown in FIG. 4.

### DETAILED DESCRIPTION OF THE PREFERRED EMBODIMENTS

The present invention is described in detail below with reference to the drawings. The scope of the present invention is not limited to the illustrated examples.

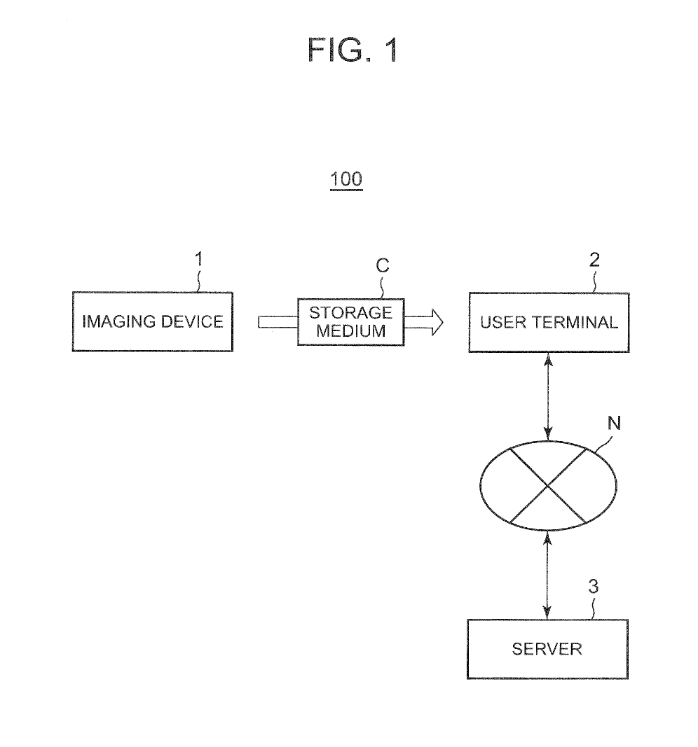

FIG. 1 is a block diagram showing a schematic configuration of the moving image generating system 100 of an embodiment employing the present invention.

As shown in FIG. 1, the moving image generating system 100 of the present embodiment includes an imaging device 1, user terminal 2, and server 3, and the user terminal 2 and the server 3 are connected to each other to enable transmitting and receiving of various pieces of information through a predetermined communication network N.

The imaging device 1 includes an imaging function to image a subject, a recording function which records image data of an imaged image on a storage medium C and the like. In other words, a well known device can be employed as the imaging device 1, for example, not only a digital camera, etc. in which the main function is the imaging function, but also a cellular telephone, etc. including an imaging function although this is not the main function.

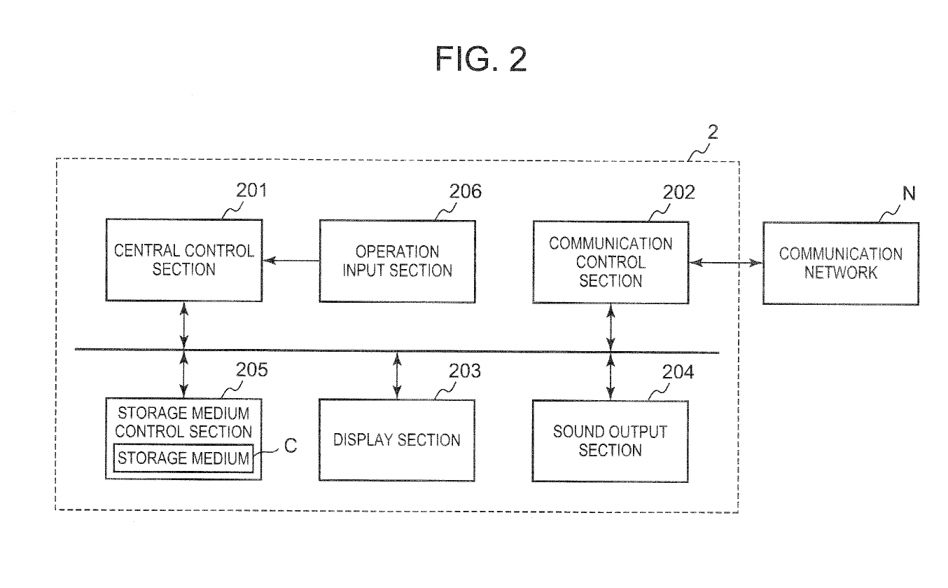

Next, the user terminal 2 is described with reference to FIG. 2.

The user terminal 2 includes, for example a personal computer, etc. to access to a Web page (for example, moving image generating page) provided by the server 3 and to input various instructions on the Web page.

FIG. 2 is a block diagram showing a schematic configuration of the user terminal 2.

As shown in FIG. 2, specifically, the user terminal 2 includes a central control section 201, a communication control section 202, a display section 203, a sound output section 204, a storage medium control section 205, an operation input section 206 and the like.

The central control section 201 controls each section of the user terminal 2. Specifically, the central control section 201 includes a CPU, a RAM, and a ROM (all not shown) and the central control section 201 performs various control operation according to various processing programs (not shown) for the user terminal 2 stored in the ROM. Here, the CPU stores various processing results in the storage area of the RAM and displays the processing result as necessary on the display section 203.

The RAM includes, for example a program storage area to expand processing programs, etc. performed by the CPU, and a data storage area for storing input data and the processing result, etc. generated when the above processing program is performed.

The ROM stores programs stored in a format of a program code readable by a computer, specifically, system programs which can be performed by the user terminal 2, various processing programs which can be performed with the system program, data used when various processing programs are performed, etc.

A communication control section 202 includes, for example, a modem (Modulator/Demodulator), a terminal adaptor, etc. and performs control of communication of information with other external devices such as the server 3, etc. through the predetermined communication network N.

The communication network N is a communication network structured using a dedicated line or an existing general public line and various forms of lines such as a LAN (Local Area Network), WAN (Wide Area Network), etc. can be applied. The communication network N includes various communication networks, such as a telephone network, an ISDN line network, a dedicated line, a cellular communication network, a communication satellite network, a CATV network, etc. and an internet service provider etc. for connecting the above.

The display section 203 includes a display such as an LCD, CRT (Cathode Ray Tube), etc. and various pieces of information are displayed on the display screen under control of the CPU of the central control section 201.

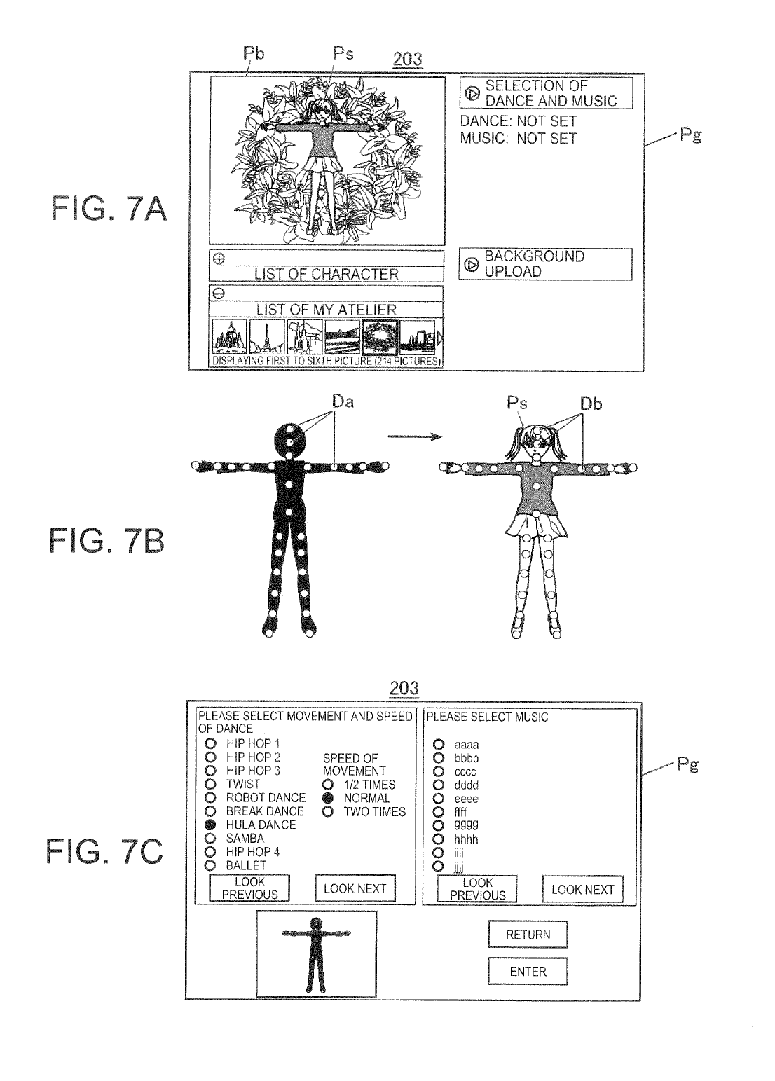

In other words, for example, based on page data of a Web page (for example, moving image generating page) received by the communication control section 202 transmitted from the server 3, the corresponding Web page is displayed on the display screen. Specifically, the display section 203 displays various processing screens on the display screen based on the image data of various processing screens of the moving image generating processing (later described) (see FIG. 7A).

The sound output section 204 includes, for example, a D/A converter, an LPF (Low Pass Filter), an amplifier, a speaker, etc. and outputs sound under control of the CPU of the central control section 201.

In other words, for example, based on play information transmitted from the server 3 and received by the communication control section 202, the sound output section 204 converts the digital data of the play information to analog data with the D/A converter, and outputs sound of a piece of music in a predetermined tone color, pitch and sound length from the speaker through the amplifier. The sound output section 204 can output sound from one sound source (for example, an instrument) or can output sound of a plurality of sound sources simultaneously.

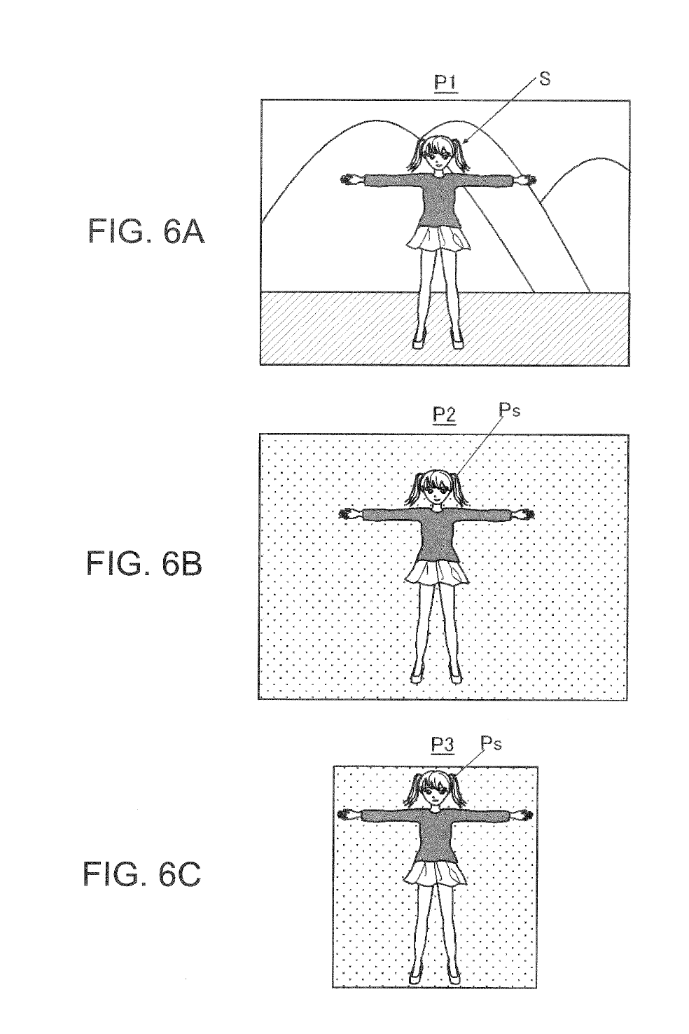

A storage medium C can be loaded on and unloaded from the storage medium control section 205 and the storage medium control section 205 controls reading of data from the loaded storage medium C and writing of data on the storage medium C. In other words, the storage medium control section 205 reads image data of a subject existing image P1 (see FIG. 6A) of moving image generating processing (later described) from the storage medium C unloaded from the imaging device 1 and loaded on the storage medium control section 205, and outputs the image data to the communication control section 202.

Here, the subject existing image P1 is an image in which a main subject exists in a predetermined background. Image data of the subject existing image P1 encoded according to a predetermined encoding format (for example, JPEG format, etc.) by an image processing section (not shown) of the imaging device 1 is recorded in the storage medium C.

Then, the communication control section 202 transmits the input image data of the subject existing image P1 to the server 3 through the predetermined communication network N.

The operation input section 206 includes a keyboard composed of data input keys for input of numerals, characters, etc., right/left/up/down movement key to perform selection of data and advancing operation, etc., and various function keys, etc.; a mouse; and the like. The operation input section 206 outputs a pressed down signal of the key pressed down by the user and an operation signal of the mouse to the CPU of the central control section 201.

A touch panel (not shown) can be provided on the display screen of the display section 203 as the operation input section 206 and various instructions can be input according to the touched position of the touch panel.

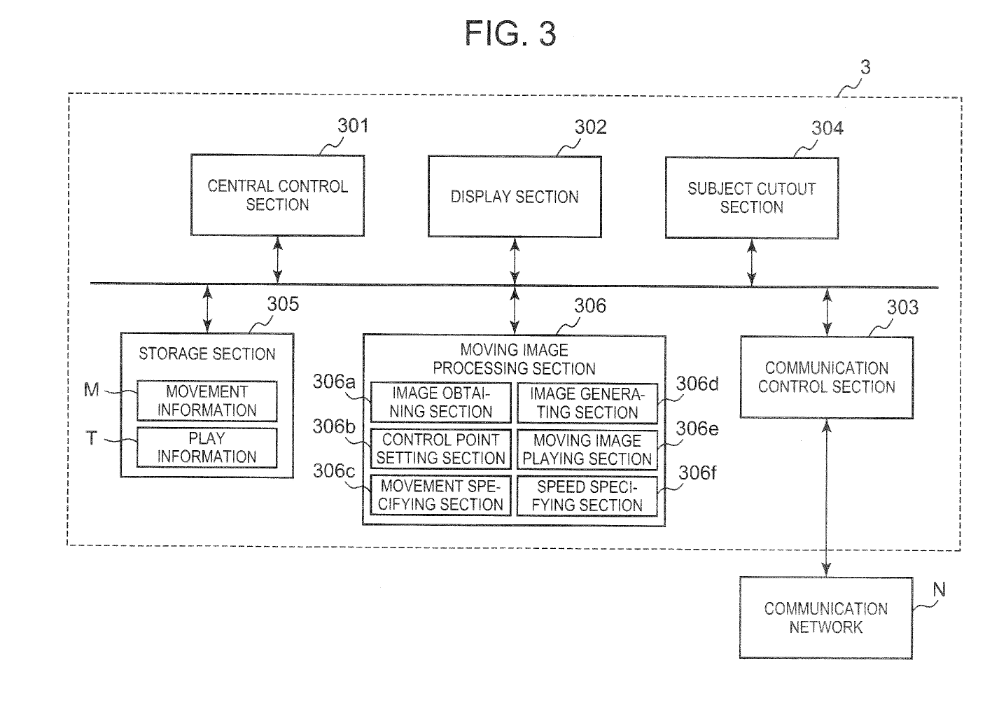

Next, the server 3 is described with reference to FIG. 3.

The server 3 includes a function as a Web (World Wide Web) server to provide a Web page (for example, moving image generating page) on the internet and transmits page data of the Web page to the user terminal 2 according to access from the user terminal 2. As the moving image generating apparatus, the server 3 sets a plurality of movement control points Db in each position corresponding to a plurality of movable points Da, etc. of movement information M in the still image and moves the plurality of control points Db, etc. so as to follow the movement of the plurality of movable points Da, etc. of the specified movement information M to generate the moving image Q.

FIG. 3 is a block diagram showing a schematic configuration of the server 3.

As shown in FIG. 3, the server 3 specifically includes, a central control section 301, a display section 302, a communication control section 303, a subject cutout section 304, a storage section 305, a moving image processing section 306, and the like.

The central control section 301 controls each section of the server 3. Specifically, the central control section 301 includes a CPU, a RAM and a ROM (all not shown) and the CPU performs various control operation according to various processing programs (not shown) for the server 3 stored in the ROM. Here, the CPU stores various processing results in the storage area of the RAM and displays the processing result as necessary on the display section 302.

The RAM includes, for example a program storage area to expand processing programs, etc. performed by the CPU, and a data storage area for storing input data and the processing result, etc. generated when the above processing program is performed.

The ROM stores programs stored in a format of a program code readable by a computer, specifically, system programs which can be performed by the server 3, various processing programs which can be performed with the system program, data used when various processing programs are performed, etc.

The display section 302 includes a display such as an LCD, CRT (Cathode Ray Tube), etc. and various pieces of information are displayed on the display screen under control of the CPU of the central control section 301.

A communication control section 303 includes, for example, a modem, a terminal adaptor, etc. and performs control of communication of information with other external devices such as the user terminal 2, etc. through the predetermined communication network N.

Specifically, for example, the communication control section 303 receives image data of subject existing image P1 transmitted through the predetermined communication network N from the user terminal 2 in the moving image generating processing (later described) and outputs the image data to the CPU of the central control section 301.

The CPU of the central control section 301 outputs input image data of the subject existing image P1 to the subject cutout section 304.

The subject cutout section 304 generates a subject cutout image P2 from the subject existing image P1.

In other words, the subject cutout section 304 uses a well known subject cutout method to generate a cutout image where the area including the subject S is cut out from the subject existing image P1. Specifically, the subject cutout section 304 obtains the image data of the subject existing image P1 output from the CPU of the central control section 301. Then, for example, based on a predetermined operation of the operation input section 206 (for example, mouse, etc.) of the user terminal 2 by the user, a boundary line (not shown) drawn on the subject existing image P1 displayed on the display section 203 divides the subject existing image P1. The subject cutout section 304 extracts the subject area including the subject S divided by the boundary line of the subject existing image P1. Then, the subject cutout section 304 sets the alpha value of the subject area to “1” and the alpha value of the background portion of the subject S to “0”, and generates image data of the subject cutout image P2 (see FIG. 6B) where the image of the subject area is combined with a predetermined single color image. In other words, in the subject cutout image P2, the transparency of the subject area in which the alpha value is “1” with respect to the predetermined background is 0% and the transparency of the background portion of the subject S in which the alpha value is “0” with respect to the predetermined background is 100%.

As image data of the subject cutout image P2, for example, image data in an RGBA format can be applied. Specifically, information of transparency A is added to each color defined in an RGB color space. The image data of the subject cutout image P2 can be image data where, for example, each pixel of the subject existing image P1 is corresponded to an alpha map in which weight when the image of the subject area is alpha blended with a predetermined background is represented by an alpha value (0≦α≦1).

The above described subject cutout method by the subject cutout section 304 is one example and does not limit the present invention. Any other well known method which cuts out the area including the subject S from the subject exiting image P1 can be applied.

The storage section 305 is composed of, for example, a nonvolatile semiconductor memory, HDD (Hard Disk Drive), etc. or the like and stores page data of the Web page transmitted to the user terminal 2, image data of the subject cutout image P2 generated by the subject cutout section 304, or the like.

The storage section 305 stores a plurality of pieces of movement information M used in the moving image generating processing.

Each piece of movement information M is information showing movement of the plurality of movable points Da, etc. in a predetermined space such as a two-dimensional plane defined by two axes (for example, x-axis, y-axis, etc.) orthogonal to each other or a three-dimensional space defined by an additional axis (for example, z-axis, etc.) orthogonal to the two axes. The movement information M can be information which provides depth to movements of the plurality of movable points Da, etc. by rotating the two-dimensional plane around a predetermined rotating axis.

Here, the position of each movable point Da is defined considering skeletal shape, position of joints, and the like of a moving body model (for example, humans, animals, etc.) which is to be a model of movement. The number of movable points Da can be set arbitrarily according to shape, size, etc. of the moving body model.

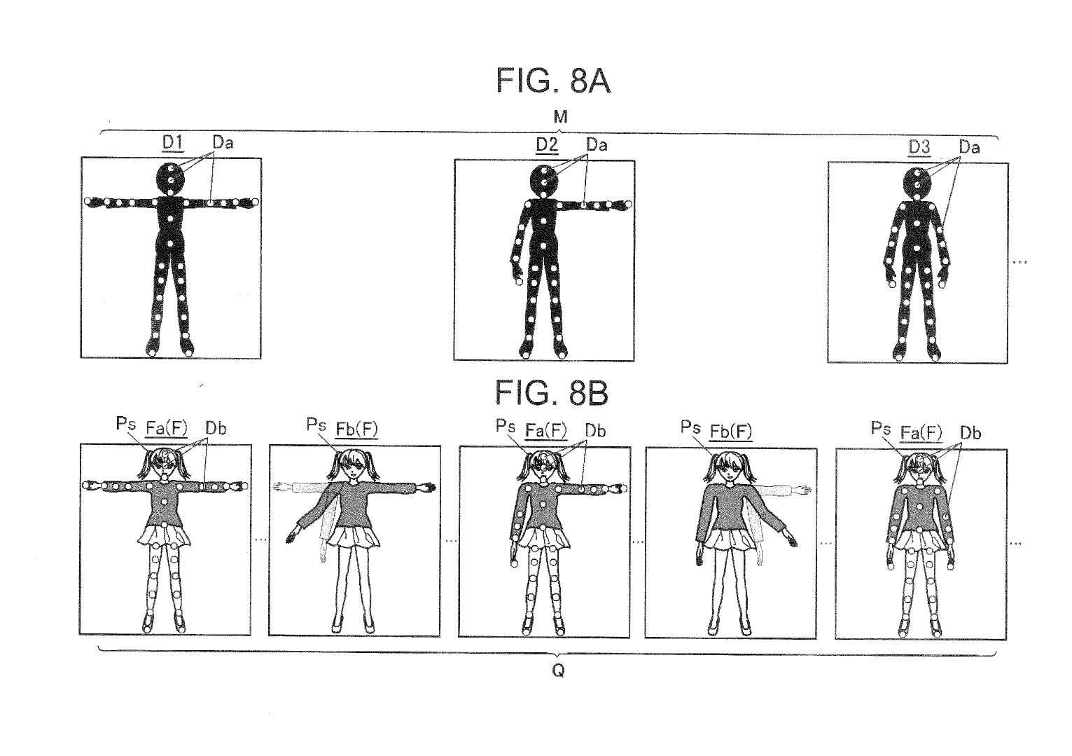

In each piece of movement information M, pieces of coordinate information in which all or at least one of the plurality of movable points Da, etc. in a predetermined space is moved are arranged successively in a predetermined time interval and the movements of the plurality of movable points Da, etc. are shown successively (see FIG. 8A). Specifically, for example, each piece of movement information M is information of a plurality of movable points Da, etc. moved to correspond to a predetermined dance. Each piece of movement information M is stored corresponded with a model name of the moving body model whose movements of the plurality of movable points Da, etc. are shown successively. In each piece of movement information M, the successive movements of the plurality of movable points Da, etc. are different according to type of movement (for example, hip hop, twist, robot dance, etc.) and variation (for example, hip hop 1 to 3, etc.).

For example, as shown in FIG. 8A, in the movement information M, coordinate information D1 of the plurality of movable points Da, etc. schematically showing a state of both arms of a moving body model of a human raised, coordinate information D2 of the plurality of movable points Da, etc. schematically showing a state of one arm lowered (arm of left side of FIG. 8), and coordinate information D3 of the plurality of movable points Da, etc. schematically showing a state of both arms lowered are arranged successively along a time axis with a predetermined time interval in between each piece of coordinate information (in FIG. 8A, illustration of coordinate information after coordinate information D3 is omitted).

Here, each piece of the coordinate information D1, D2, D3, etc. of the plurality of movable points Da, etc. may be, for example, information defining movement amount of each movable point Da from coordinate information (for example, coordinate information D1, etc.) of the movable point Da which is to be a standard, or information defining an absolute position coordinate of each movable point Da.

The movement information M shown in FIG. 8A is one example, and does not limit the scope of the invention. The type of movement, etc. can be changed arbitrarily.

As described above, the storage section 305 composes a storage section which stores in advance a plurality of pieces of movement information M showing movements of a plurality of movable points Da, etc. in a predetermined space.

The storage section 305 stores a plurality of pieces of play information T used in the moving image generating processing.

The play information T is information played with a moving image Q by a moving image playing section 306e. In other words, for example, a plurality of pieces of play information T are defined with different tempo, measure, musical interval, musical scale, key, idea slogan, etc. and each piece of play information T is stored corresponded with a name of a piece of music.

For example, each piece of play information T is digital data defined according to MIDI (Musical Instruments Digital Interface) standard, etc. and specifically includes, header information defining track number, resolution of quarter note (Tick count number), etc., track information defining the play information T, etc. according to each sound source (for example, instrument, etc.), and the like. The track information defines setting information of tempo and measure, timing of Note On and Off, and the like.

The moving image processing section 306 includes an image obtaining section 306a, a control point setting section 306b, a movement specifying section 306c, an image generating section 306d, a moving image playing section 306e, and a speed specifying section 306f.

The image obtaining section 306a obtains a still image used in the moving image generating processing.

In other words, the image obtaining section 306a obtains the subject cutout image P2 where the area including the subject S is cutout from the subject existing image P1 including the background and the subject S as the still image. Specifically, the image obtaining section 306a obtains the image data of the subject cutout image P2 generated by the subject cutout section 304 as the still image of the processing target.

The control point setting section 306b sets a plurality of movement control points Db in the still image of the processing target.

In other words, the control point setting section 306b sets a plurality of movement control points Db in each position corresponding to the plurality of movable points Da, etc. in the subject image Ps of the subject cutout image P2 obtained by the image obtaining section 306a. Specifically, the control point setting section 306b reads movement information M of a moving body model (for example, human) from the storage section 305 and identifies a position corresponding to each of the plurality of movable points Da, etc. of a standard frame (for example, first frame, etc.) defined in the movement information M in the subject image Ps of the subject cutout image P2. For example, when the subject image Ps is an image of a human cut out as the main subject S (see FIG. 7B), the control point setting section 306 identifies the position corresponding to each of the plurality of movable points Da, etc. considering the skeletal shape, the position of joints, etc. of a human. Here, dimension of the moving body model and the subject image Ps can be adjusted (for example, enlargement and reduction, deformation, etc. of the moving body model) to match to the size of main portions such as a face. Alternatively, for example, the moving body model and the subject image Ps can be overlapped to identify the position corresponding to each of the plurality of movable points Da, etc. in the subject image Ps.

Then, the control point setting section 306b sets a movement control point Db in the position corresponding to each of the identified plurality of movable points Da.

The setting of the movement control point Db by the control point setting section 306b can be performed automatically as described above, or can be performed manually. In other words, for example, the movement control point Db can be set in a desired position input based on a predetermined operation of the operation input section 206 of the user terminal 2 by the user.

Even when the setting of the movement control point Db by the control point setting section 306b is performed automatically, the control point setting section 306b can receive modification (change) of the setting position of the control section Db based on a predetermined operation of the operation input section by the user.

The movement specifying section 306c specifies the movement information M used in the moving image generating processing.

In other words, the movement specifying section 306c specifies any one piece of the movement information M among the plurality of pieces of movement information M, etc. stored in the storage section 305. Specifically, when an instruction which specifies a model name (for example, hip hop 1, etc.) of any one of the plurality of model names of movement models in a predetermined screen displayed on the display section 203 based on a predetermined operation of the operation input section 206 of the user terminal 2 by the user is input through the communication network N and the communication control section 303, the movement specifying section 306c specifies the movement information M corresponding to the model name of the movement model of the specified instruction from the plurality of pieces of movement information M, etc.

For example, the movement specifying section 306c can automatically specify the movement information M set as default or the movement information M specified previously by the user from among the plurality of pieces of movement information M, etc.

The image generating section 306d successively generates a plurality of frame images F, etc. composing the moving image Q.

In other words, the image generating section 306d moves the plurality of control points Db, etc. set in the subject image Ps of the subject cutout image P2 so as to follow the movements of the plurality of movable points Da, etc. of the movement information M specified by the movement specifying section 306c to successively generate the plurality of frame images F, etc. Specifically, for example, the image generating section 306d successively obtains the coordinate information of the plurality of movable points Da, etc. which move in a predetermined time interval based on the movement information M and calculates the coordinate of each control point Db corresponding to each movable point Da. Then, the image generating section 306d successively moves the control point Db to the calculated coordinate and moves and deforms a predetermined image area (for example, a triangular or rectangular meshed area) set in the subject image Ps with at least one control point Db as the standard to generate a standard frame image Fa (see FIG. 8B). With this, for example, the standard frame image Fa (see FIG. 8B) in which the control point Db is provided in the position corresponding to each piece of coordinate information D1, D2 and D3 (see FIG. 8B) of the plurality of movement points Da, etc. of the movement information M is generated. FIG. 8B virtually shows each control point Db and each control point Db is not actually included in the standard frame image Fa.

The processing of moving and deforming the predetermined image area with the control point Db as the standard is well known art and therefore the detailed description is omitted.

The image generating section 306d generates an interpolation image Fb which interpolates between two standard frames Fa and Fa adjacent along a time axis generated based on the plurality of control points Db, etc. corresponding to each of the movable points Da after movement (see FIG. 8B). In other words, the image generating section 306d generates a predetermined number of interpolation frame image Fb to interpolate between two standard frame images Fa and Fa in order to play the plurality of frame images F in a predetermined play frame rate (for example, 30 fps, etc.) with the moving image playing section 306e.

Specifically, the image generating section 306d successively obtains the degree of progress of playing of a predetermined piece of music played by the moving image playing section 306e between two adjacent standard frame images Fa and Fa. According to the degree of progress, the moving image playing section 306e successively generates the interpolation frame image Fb played between the two adjacent standard frame images Fa and Fa. For example, the image generating section 306d obtains the setting information of the tempo and the resolution of the quarter note (Tick count number) based on play information T in a MIDI standard and time passed in playing the predetermined piece of music played by the moving image playing section 306e is converted to a Tick count number. Then, the image generating section 306d calculates a percentage of the relative degree of progress in playing the predetermined piece of music between the two adjacent standard frame images Fa and Fa synchronized to a predetermined timing (for example, first beat of each bar, etc.) based on the Tick count number corresponding to the time passed in playing the predetermined piece of music. Then, the image generating section 306d generates the interpolation frame image Fb changing the weighting of the two adjacent standard frame images Fa and Fa according to the relative degree of progress in playing the predetermined piece of music.

Here, when the tempo or measure is changed between the predetermined timing to which the two adjacent standard frame images Fa and Fa are each synchronized and the calculated degree of progress is smaller than the previously calculated degree of progress, the relative degree of progress in playing the predetermined piece of music can be corrected so that the degree of reduction of the degree of progress becomes small. With this, a more suitable interpolation frame image Fb can be generated considering the degree of progress of the piece of music.

The processing of generating the interpolation frame image Fb is well known art, therefore, the detailed description is omitted here.

For example, when the image data is in an RGBA format, the generating of the standard frame image Fa and interpolation frame image Fb by the image generating section 306d is performed for both information of each color and information of transparency A of the subject image Ps defined in the RGB color space.

In the setting processing of the control point Db by the control point setting section 306b, when the control point Db corresponding to the movable point Da is set in a position separated a predetermined distance or more from a position of the movable point Da of the standard frame of the movement information M, the standard frame image Fa can be generated considering the distance between the movable point Da and the control point Db.

In other words, when each piece of coordinate information D1, D2, D3, etc. of the plurality of movable points Da is information defining the movement amount of each movable point Da with respect to the coordinate information of the standard movable point Da (for example, coordinate information D1, etc.), the position of the control point Db moved according to the movement amount of each movable point Da corresponding to the coordinate information after the coordinate information of the standard movable point Da (for example, coordinate information D2, D3, etc.) is separated a predetermined distance or more with respect to the position of the movable point Da defined in advance in the movement information M. As a result, there is a possibility that the generated standard frame image Fa cannot recreate the movement of the movable point Da defined in the movement information M.

Therefore, the coordinate of the control point Db corresponding to each movable point Da can be calculated by adding the distance between the standard movable point Da and the control point Db corresponding to the movable point Da to the movement amount of each of the movable point Da for the coordinate information (for example, coordinate information D2, D3, etc.) after the coordinate information of the standard movable point Da.

The moving image playing section 306e plays each of the plurality of frame images F generated by the image generating section 306d.

In other words, the moving image playing section 306e plays a predetermined piece of music based on the play information T specified based on a predetermined operation of the operation input section 206 of the user terminal 2 by the user and also plays each of the plurality of frame images F, etc. at a predetermined timing of the predetermined piece of music. Specifically, the moving image playing section 306e converts the digital data of the play information of the predetermined piece of music to analog data with the D/A converter to play the predetermined piece of music. Here, the moving image playing section 306e plays the two adjacent standard frame images Fa and Fa so as to synchronize with a predetermined timing (for example, first beat of each bar, each beat, etc.) and also plays each interpolation frame image Fb corresponding to the degree of progress according to the relative degree of progress in playing the predetermined piece of music between the two adjacent standard frame images Fa and Fa.

The moving image playing section 306e can play the plurality of frame images F, etc. of the subject image Ps at a speed specified with the speed specifying section 306f (later described). In this case, the moving image playing section 306e changes the timing to which the two adjacent standard frame images Fa and Fa are synchronized and changes the number of frame images F played in a predetermined unit time so as to change the speed of the movement of the subject image Ps.

The speed specifying section 306f specifies the speed of the movement of the subject image Ps.

In other words, the speed specifying section 306f specifies the speed of movement of the plurality of movement control points Db set by the control point setting section 306b. Specifically, based on a predetermined operation of the operation input section 206 of the user terminal 2 by the user, an instruction to specify any one speed (for example, normal, etc.) from among a plurality of speeds (for example, ½ times, normal (same speed), two times, etc.) of the subject image Ps in a predetermined screen displayed on the display section 203 is input to the server 3 through the communication network N and the communication control section 303. The speed specifying section 306f specifies the speed specified by the instruction from among the plurality of movement speeds as the movement speed of the subject image Ps.

With this, the number of frame images F switched at a predetermined unit time is changed to, for example, ½ times, same speed, two times, etc.

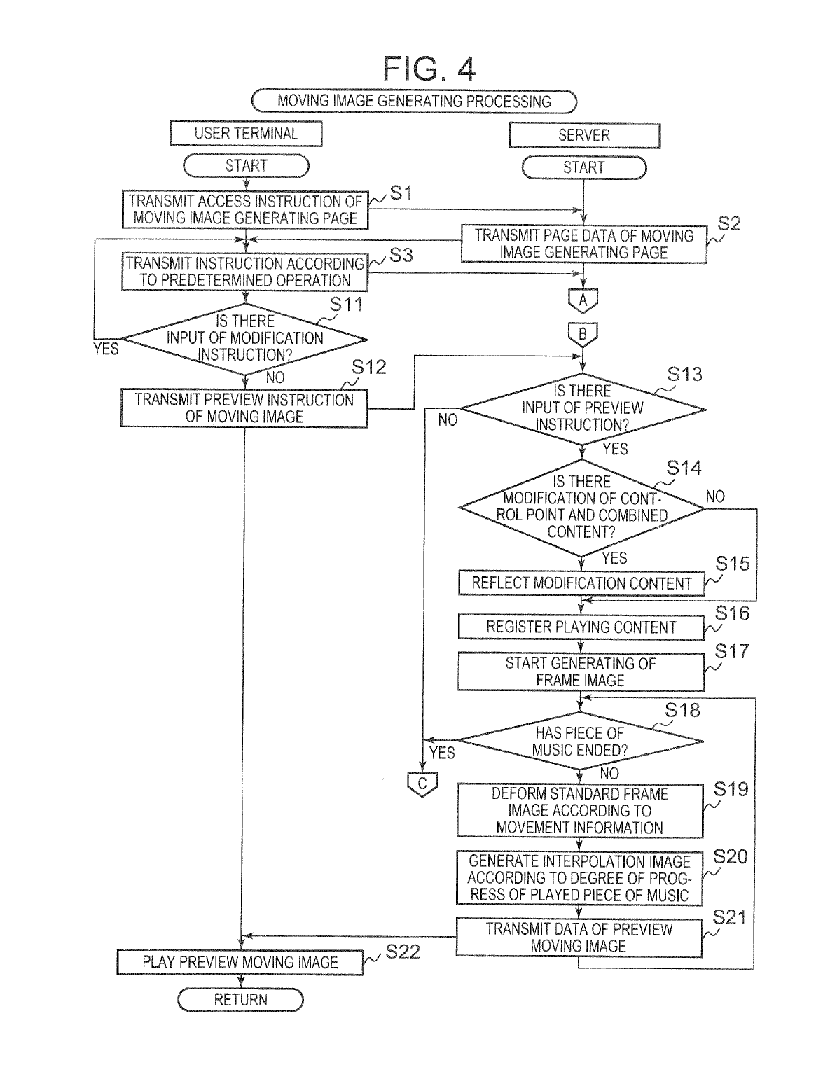

Next, the moving image generating processing using the user terminal 2 and the server 3 is described with reference to FIG. 4 to FIG. 8.

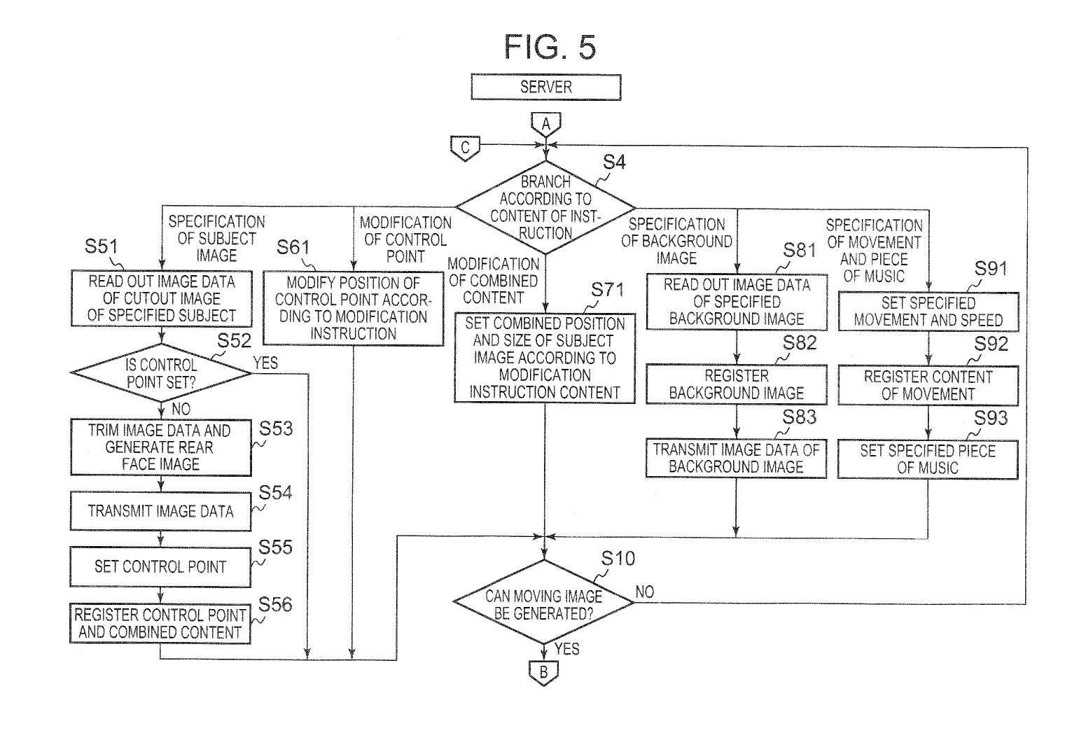

FIG. 4 and FIG. 5 show a flowchart showing an example of an operation of moving image generating processing. FIG. 6A to FIG. 6C are diagrams schematically showing an example of an image of the moving image generating processing. FIG. 7A and FIG. 7C are diagrams schematically showing an example of a display screen displayed on the display section 203 of the user terminal 2 in the moving image generating processing and FIG. 7B is a diagram schematically showing an example of a corresponding relation between the movable point Da and the control point Db. FIG. 8A is a diagram schematically showing an example of the movement information M and FIG. 8B is a diagram schematically showing an example of a frame image F composing the moving image Q.

In the description below, the image data of the subject cutout image P2 (see FIG. 6B) generated from the image data of the subject existing image P1 is stored in the storage section 305 of the server 3. The movement information M (see FIG. 8A) in which a human is a moving body model is stored in the storage section 305.

As shown in FIG. 4, when an access instruction of a moving image generating page provided by the server 3 is input based on a predetermined operation of the operation input section 206 by the user, the CPU of the central control section 201 of the user terminal 2 transmits the access instruction with the communication control section 202 through the predetermined communication network N to the server 3 (step S1).

When the communication control section 303 of the server 3 receives the access instruction transmitted from the user terminal 2, the CPU of the central control section 301 transmits the page data of the moving image generating page with the communication control section 303 through the predetermined communication network N to the user terminal 2 (step S2).

Then, when the communication control section 202 of the user terminal 2 receives the page data of the moving image generating page, the display section 203 displays a screen Pg of the moving image generating page based on the page data of the moving image generating page (see FIG. 7A).

Next, based on a predetermined operation of the operation input section 206 by the user, the central control section 201 of the user terminal 2 transmits the instruction signal corresponding to various buttons operated in the screen Pg of the moving image generating page with the communication control section 202 through the predetermined communication network N to the server 3 (step S3).

As shown in FIG. 5, the CPU of the central control section 301 of the server 3 branches the processing according to the content of the instruction from the user terminal 2 (step S4). Specifically, when the content of the instruction from the user terminal 2 is regarding the specification of the subject image Ps (step S4; specification of subject image), the CPU of the central control section 301 advances the processing to step S51. When the content of the instruction is regarding the modification of the control point Db (step S4; modification of control point), the processing advances to step S61. When the content of the instruction is regarding the modification of the combined content (step S4; modification of combined content), the processing advances to step S71. When the content of the instruction is regarding the specification of the background image Pb (step S4; specification of background image), the processing advances to step S81. When the content of the instruction is regarding the specification of the movement and the piece of music (step S4; specification of movement and piece of music), the processing advances to step S91.

### <Specification of Subject Image>

In step S4, when the content of the instruction from the user terminal 2 is regarding the specification of the subject image Ps (step S4; specification of subject image), the image obtaining section 306a of the moving image processing section 306 reads out image data of the subject cutout image P2 specified by the user from the image data of the subject cutout image P2 stored in the storage section 305 and obtains the data (step S51).

Next, the control point setting section 306b judges whether or not the control point Db of the movement is already set in the subject image Ps of the obtained subject cutout image P2 (step S52).

In step S52, when it is judged that the movement control point Db is not set (step S52; NO), the control point setting section 306b performs trimming of the subject cutout image P2 based on the image data of the subject cutout image P2, and adds an image of a predetermined color to the rear face of the subject image Ps of the trimmed image P3 to generate a rear face image (not shown) (step S53).

Specifically, the control point setting section 306b performs trimming of the subject cutout image P2 based on the image data of the subject cutout image P2 using a predetermined position (for example, center or a position of a face of a person, etc.) of the subject image Ps as a standard to perform correction so that the size of the subject image Ps and the movement model (for example, human) become the same (step S53). The trimmed image P3 of the subject cutout image P2 is shown in FIG. 6C.

Here, for example, when the subject image Ps is a human, the control point setting section 306b can perform trimming so that a central section such as a face or a backbone of the human is provided along a center in a left and right direction of the trimmed image P3.

For example, when the image data is in an RGBA format, the trimming of the subject cutout image P2 is performed on information of each color of the subject image Ps defined in the RGB color space and the information of transparency A.

Next, the CPU of the central control section 301 transmits the image data of the trimmed image P3 with the communication control section 303 through the predetermined communication network N to the user terminal 2 (step S54). Then, the control point setting section 306b sets a plurality of movement control points Db in each position corresponding to the plurality of movable points Da, etc. in the subject image Ps of the trimmed image P3 (step S55; See FIG. 7B).

Specifically, the control point setting section 306b reads out movement information M of the moving body model (for example, human) from the storage section 305 and after identifying the position corresponding to each of the plurality of moveable points Da, etc. defined in the movement information M in the subject image Ps of the subject cutout image P2, the control point setting section 306b sets each movement control point Db in the position corresponding to each of the plurality of movable points Da, etc.

Then, the moving image playing section 306e registers the plurality of control points Db, etc. set in the subject image Ps and the combined content of the combined position, size, etc. of the subject image Ps in a predetermined storage section (for example, predetermined memory, etc.) (step S56).

Then, the CPU of the central control section 301 advances the processing to step S10. The content of the processing of step S10 is described later.

In step S52, when it is judged that the movement control point Db is already set (step S52; YES), the CPU of the central control section 301 skips the processing of steps S53 to S56 and advances the processing to step S10.

### <Modification of Control Point>

In step S4, when the content of the instruction from the user terminal 2 is regarding the modification of the control point Db (step S4; modification of control point) the control point setting section 306b of the moving image processing section 306 modifies the position of the movement control point Db based on a predetermined operation of the operation input section 206 by the user (step S61).

In other words, as shown in FIG. 4, in step S11, when the central control section 201 of the user terminal 2 judges that an instruction to modify the set control point Db is input based on a predetermined operation of the operation input section 206 by the user (step S11; YES), a signal corresponding to the modification instruction is transmitted with the communication control section 202 through the predetermined communication network N to the server 3 (step S3).

Then, as shown in FIG. 5, the control point setting section 306b of the moving image processing section 306 sets the movement control point Db in a desired position input based on a predetermined operation of the operation input section 206 by the user (step S61).

Then, the CPU of the central control section 301 advances the processing to step S10. The content of the processing of step S10 is described later.

### <Modification of Combined Content>

In step S4, when the content of the instruction from the user terminal 2 is regarding the modification of the combined content (step S4; modification of combined content), the moving image processing section 306 sets the combined position and the size of the subject image Ps based on a predetermined operation of the operation input section 206 by the user (step S71).

In other words, as shown in FIG. 4, in step S11, when the central control section 201 of the user terminal 2 judges that the modification instruction of the combined position and the size of the subject image Ps is input based on a predetermined operation of the operation input section 206 by the user (step S11; YES), the signal corresponding to the modification instruction is transmitted with the communication control section 202 through the predetermined communication network N to the server 3 (step S3).

Then, as shown in FIG. 5, the moving image processing section 306 sets the combined position of the subject image Ps to a desired combined position and sets the size of the subject image Ps to a desired size based on a predetermined operation of the operation input section 206 by the user (step S71).

Then, the CPU of the central control section 301 advances the processing to step S10. The content of the processing of step S10 is described later.

### <Specification of Background Image>

In step S4, when the content of the instruction from the user terminal 2 is regarding the specification of the background image Pb (step S4; specification of background image), the moving image playing section 306e of the moving image processing section 306 reads out the image data of the desired background image (another image) Pb based on a predetermined operation of the operation input section 206 by the user (step S81) and registers the image data of the background image Pb as the background of the moving image Q in the predetermined storage section (step S82).

Specifically, an instruction to specify any one of the pieces of image data specified based on a predetermined operation of the operation input section 206 by the user in the plurality of image data in the screen Pg of the moving image generating page displayed on the display section 203 of the user terminal 2 is input through the communication network N and the communication control section 303 to the server 3. After reading out and obtaining from the storage section 305 the image data of the background image Pb of the specifying instruction (see FIG. 7A) (step S81), the moving image playing section 306e registers the image data of the background image Pb as the background of the moving image Q (step S82).

Next, the CPU of the central control section 301 transmits the image data of the background image Pb with the communication control section 303 through the predetermined communication network N to the user terminal 2 (step S83).

Then, the CPU of the central control section 301 advances the processing to step S10. The content of the processing of S10 is described later.

### <Specification of Movement and Piece of Music>

In step S4, when the content of the instruction from the user terminal 2 is regarding the specification of the movement and the piece of music (step S4; specification of movement and piece of music), the moving image processing section 306 sets the movement information M and the movement speed based on a predetermined operation of the operation input section 206 by the user (step S91).

Specifically, an instruction to specify any one of the model name (for example, hula dance, etc.) specified based on a predetermined operation of the operation input section 206 by the user from among the model name of the plurality of movement models in the screen Pg of the moving image generating page displayed on the display section 203 of the user terminal 2 is input through the communication network N and the communication control section 303 to the server 3. The movement specifying section 306c of the moving image processing section 306 sets the movement information M corresponded to the model name of the movement model of the specifying instruction from among the plurality of pieces of movement information M, etc. stored in the storage section 305. Moreover, an instruction to specify any one of the speed (for example, normal, etc.) specified based on a predetermined operation of the operation input section 206 by the user from among the plurality of movement speeds in the screen Pg of the moving image generating page displayed in the display section 203 of the user terminal 2 is input through the communication network N and the communication control section 303 to the server 3. The speed specifying section 306f of the moving image processing section 306 sets the speed of the specifying instruction as the speed of the movement of the subject image Ps.

Then, the moving image playing section 306e of the moving image processing section 306 registers the set movement information M and the set movement speeds as the content of the movement of the moving image Q in a predetermined storage section (step S92).

Next, the moving image processing section 306 sets the piece of music to be played together with the moving image based on a predetermined operation of the operation input section 206 by the user (step S93).

Specifically, an instruction to specify any one of the name of the piece of music specified based on the predetermined operation of the operation input section 206 by the user from among the plurality of names of pieces of music in the screen Pg of the moving image generating page displayed on the display section 203 of the user terminal 2 is input to the server 3 through the communication network N and the communication control section 303. The moving image processing section 306 sets the piece of music with the name of the piece of music specified by the instruction.

Then, the CPU of the central control section 301 advances the processing to step S10. The content of the processing of step S10 is described later.

In step S10, the CPU of the central control section 301 judges whether or not the moving image Q can be generated (step S10). In other words, based on a predetermined operation of the operation input section 206 by the user, the moving image processing section 306 of the server 3 performs the registration of the control point Db of the subject image Ps, the registration of the content of the movement of the subject image Ps, the registration of the background image Pg, etc. to prepare for generation of the moving image Q and judges whether or not the moving image Q can be generated.

Here, when it is judged that the moving image Q cannot be generated (step S10; NO), the CPU of the central control section 301 returns the processing to step S4 and branches the processing according to the content of the instruction from the user terminal 2 (step S4).

When it is judged that the moving image Q can be generated (step S10; YES), the CPU of the central control section 301 advances the processing to step S13 as shown in FIG. 4.

In step S13, the CPU of the central control section 301 of the server 3 judges whether or not a preview instruction of the moving image Q is input based on a predetermined operation of the operation input section 206 of the user terminal 2 by the user (step S13).

In other words, in step S11, after the central control section 201 of the user terminal 2 judges the modification instruction of the combined position and the size of the subject image Ps is not input (step S11; NO), the preview instruction of the moving image Q input based on the predetermined operation of the operation input section 206 by the user is transmitted with the communication control section 202 through the predetermined communication network N to the server 3 (step S12).

Then, in step S13, when the CPU of the central control section 301 of the server 3 judges the preview instruction of the moving image Q is input (step S13; YES), the moving image processing section 306 judges whether or not there is a modification in the position or the combined content of the control point Db (step S14). In other words, the moving image processing section 306 judges in step S61 whether the position of the control point Db is modified and judges in step S71 whether the size or the combined position of the subject image Ps is modified.

In step S14, when it is judged that the position or the combined content of the control point Db is modified (step S14; YES), the moving image playing section 306e performs re-registration of the position of the control point Db and the re-registration of the combined position and the size of the subject image Ps to reflect the modified content (step S15).

Next, the moving image playing section 306e of the moving image processing section 306 registers the play information T corresponding to the set name of the piece of music together with the moving image Q as information automatically played in a predetermined storage section (step S16).

In step S14, when it is judged that there is no modification of the position or the combined content of the control point Db (step S14; NO), the moving image processing section 306 skips the processing of step S15 and advances the processing to step S16.

Next, the moving image processing section 306 starts playing a predetermined piece of music with the moving image playing section 306f based on the play information T registered in the storage section and also starts generating the plurality of frame images F, etc. composing the moving image Q with the image generating section 306d (step S17).

Next, the moving image processing section 306 judges whether or not the playing of the predetermined piece of music by the moving image playing section 306f has ended (step S18).

Here, when it is judged that the playing of the piece of music has not ended (step S18; NO), the image generating section 306d of the moving image processing section 306 generates the standard frame image Fa of the subject image Ps deformed according to the movement information M (see step S19; FIG. 8B). Specifically, the image generating section 306d obtains the coordinate information of the plurality of movable points Da, etc. which move in a predetermined time interval according to the movement information M registered in the storage section and calculates the coordinate of each control point Db corresponding to each of the movable points Da. Then, the image generating section 306d successively moves the control point Db to the calculated coordinate and also moves and/or deforms the predetermined image area set in the subject image Ps according to the movement of the control point Db to generate the standard frame image Fa.

The moving image processing section 306 combines the standard frame image Fa with the background image (another image) Pb using a well known image combining method. Specifically, for example, among the pixels of the background image Pb, the moving image processing section 306 sets the pixel with an alpha value of “0” to be transparent and overwrites the pixel with an alpha value of “1” with the pixel value of the pixel corresponding to the standard frame image Fa. Moreover, among the pixels of the background image Pb, regarding the pixel with the alpha value of “0<α<1”, after generating the image in which the subject area of the standard frame image Fa is cutout (background image×(1−α)) using the complement of 1 (1−α), the value blended with the single background color when the standard frame image Fa is generated using the complement of 1 (1−α) of the alpha map is calculated. The value is subtracted from the standard frame image Fa and the above is combined with the image in which the subject area is cutout (background image×(1−α)).

Next, the image generating section 306d generates the interpolation frame image Fb which interpolates between two adjacent standard frame images Fa and Fa according to the degree of progress of playing a predetermined piece of music played by the moving image playing section 306e (see step S20; FIG. 8B). Specifically, the image generating section 306d successively obtains the degree of progress of playing the predetermined piece of music played by the moving image playing section 306e between the two adjacent standard frame images Fa and Fa, and according to the degree of progress, successively generates the interpolation frame image Fb played between the two adjacent standard frame images Fa and Fa.

Moreover, the moving image processing section 306 combines the interpolation frame image Fb with the background image (another image) Pb similar to the above standard frame image Fa using a well known image combining method.

Next, the CPU of the central control section 301 transmits play information of the piece of music automatically played by the moving image playing section 306e together with the data of the preview moving image including the standard frame image Fa and the interpolation frame image Fb played at a predetermined timing of the piece of music using the communication control section 303 through the communication network N to the user terminal 2 (step S21). Here, the data of the preview moving image includes combined moving images of a plurality of frame images F including a predetermined number of standard frame images Fa and interpolation frame images Fb and a background image Pb (another image) desired by the user.

Next, the moving image processing section 306 returns the processing to step S18 and judges whether or not the playing of the piece of music has ended (step S18).

The above processing is performed repeatedly until it is judged that the playing of the piece of music has ended in step S18 (step S18; YES).

Then, when it is judged that the playing of the piece of music has ended (step S18; YES), as shown in FIG. 5, the CPU of the central control section 301 returns the processing to step S4 and branches the processing according to the content of the instruction from the user terminal 2 (step S4).

In step S21, when the communication control section 303 of the user terminal 2 receives data of the preview moving image transmitted from the server 3, the CPU of the central control section 201 controls the sound output section 204 and the display section 203 to play the preview moving image (step S22).

Specifically, the sound output section 204 automatically plays the piece of music based on the play information and outputs the sound from the speaker. Simultaneously, the display section 203 displays on the display screen the preview moving image including the standard frame image Fa and the interpolation frame image Fb at a predetermined timing of the piece of music automatically played.

In the moving image generating processing, the preview moving image is played, however, this is one example and is not limited to the above. For example, the pieces of image data of the standard frame image Fa, interpolation frame image Fb and the background image which are successively generated and the play information can be stored in a predetermined storage section as one file, and after all of the pieces of data regarding the moving image Q are generated, the file can be transmitted from the server 3 to the user terminal 2 to be played on the user terminal 2.

As described above, according to the moving image generating system 100 of the present embodiment, the plurality of movement control points Db are set in each position corresponding to the plurality of movable points Da, etc. of the movement information M in the still image (for example, subject image Ps) of the processing target and the plurality of control points Db, etc. are moved so as to follow the movements of the plurality of movable points Da, etc. of the specified movement information M to generate the moving image Q. In other words, the plurality of pieces of movement information M showing the movements of the plurality of movable points Da, etc. in the predetermined space are stored in advance and the plurality of control points Db, etc. set in the still image corresponded to the plurality of movable points Da, etc. are moved so as to follow the movements of the plurality of movable points Da, etc. of the specified movement information M to generate each frame image F composing the moving image Q. Therefore, it is not necessary to specify movement for each control point Db as in conventional techniques.

Therefore, by simply specifying one of the pieces of movement information M from among a plurality of pieces of movement information M, etc. the user can easily generate a moving image Q which recreates movement desired by the user.

Moreover, based on a specification of a model name according to a predetermined operation of the operation input section 206 by the user, the movement information M corresponded to the model name can be specified. Therefore, it is possible to specify one of the pieces of movement information M from among the plurality of pieces of movement information M, etc. more easily and it is possible to generate the moving image Q recreating the movement desired by the user easily.

Further, by moving the plurality of control points Db, etc. so as to follow the movement of the plurality of movable points Da, etc. based on movement information M in which the plurality of movable points Da, etc. are moved to correspond to a predetermined dance, frame images F composing a moving image Q recreating a predetermined dance can be generated. Therefore, it is possible to easily generate a moving image Q which recreates movement of the dance desired by the user.

The present invention is not limited to the above described embodiments, and various modifications and changes in design are possible without leaving the scope of the invention.

For example, according to the above described embodiment, the moving image Q is generated by the server (moving image generating apparatus) 3, which functions as a Web server, based on a predetermined operation of the user terminal 2 by the user. However, this is one example, the configuration is not limited to the above and the configuration of the moving image generating apparatus can be changed arbitrarily. In other words, the function of the moving image processing section 306 regarding the generating of the moving image Q can be realized with a configuration of installing software in the user terminal 2. With this, the communication network N is not necessary and the moving image generating processing can be performed by the user terminal 2 itself.

According to the present embodiment, a personal computer is illustrated as the user terminal 2, however, this is one example and the configuration is not limited to the above. The configuration can be changed arbitrarily, and for example, a portable telephone, etc. can be employed.

The data of the subject cutout image P2 and the moving image Q can be embedded with control information to prohibit certain modifications by the user.

Moreover, according to the present embodiment the functions of an obtaining section, a setting section, a frame image generating section and a moving image generating section are realized by driving the image obtaining section 306a, control point setting section 306b, image generating section 306d and moving image processing section 306 under control of the central control section 301. However, the embodiment is not limited to the above, and a configuration in which the CPU of the central control section 301 performs a predetermined program, etc. to realize the above functions is possible.

In other words, a program memory (not shown) which stores a program stores a program including an obtaining processing routine, a setting processing routine, a frame image generating processing routine, and a moving image generating processing routine. The CPU of the central control section 301 can function as the obtaining section which obtains the still image with the obtaining processing routine. The CPU of the central control section 301 can functions as the setting section which sets a plurality of movement control points Db in each position corresponding to the plurality of movable points Da, etc. in the obtained still image with the setting processing routine. The CPU of the central control section 301 can function as the specifying section in which one of the pieces of movement information M is specified from among the plurality of pieces of movement information M, etc. stored in the storage section with the specifying processing routine. The CPU of the central control section 301 can function as the frame image generating section which generates a plurality of frame images F in which the still image is deformed according to the movement of the control point Db by moving the plurality of control points Db based on the movements of the plurality of movable points Da, etc. of the movement information M specified by the specifying section with the frame image generating processing routine. The CPU of the central control section 301 can function as the moving image generating section which generates the moving image Q from the plurality of frames F generated by the frame image generating section with the moving image generating processing routine.

Other than a ROM or hard disk, etc., a nonvolatile memory such as a flash memory, etc., a portable storage medium such as a CD-ROM, etc., or the like can be employed as the computer readable medium which stores the program to perform the above processing. A carrier wave can be employed as the medium which provides the data of the program through the predetermined communication line.

The entire disclosure of Japanese Patent Application No. 2011-125663 filed on Jun. 3, 2011 including specification, claims, drawings and abstract are incorporated herein by reference in its entirety.

What is claimed is:

1. A moving image generating method which uses a moving image generating apparatus which stores in advance a plurality of pieces of movement information showing movements of a plurality of movable points in a predetermined space, the method comprising:
an obtaining step which obtains a still image;
a setting step which sets a plurality of movement control points in each position corresponding to the plurality of movable points in the still image obtained in the obtaining step;
a frame image generating step which moves the plurality of control points based on movements of the plurality of movable points of one piece of movement information specified by a user from among the plurality of pieces of movement information and deforms the still image according to the movements of the control points to generate a plurality of frame images; and
a moving image generating step which generates a moving image from a plurality of frames generated in the frame image generating step.

2. The moving image generating method according to claim 1, wherein:
the movement information is stored corresponded with a model name of a movement model in which the movements of the plurality of movable points are shown successively; and
in the frame image generating step, the plurality of control points are moved based on the movements of the plurality of movable points of movement information corresponded to the model name according to a predetermined operation by a user.

3. The moving image generating method according to claim 1, wherein the movement information includes movement information of moving the plurality of movable points to correspond to a predetermined dance.

4. The moving image generating method according to claim 1, wherein:
in the obtaining step, a cutout image in which an area including a subject is cutout from an image including a background and the subject is obtained as the still image; and
in the moving image generating step, a plurality of frame images generated from the cutout image are combined to another image to generate a moving image.

5. The moving image generating method according to claim 1, wherein in the frame image generating step, an interpolation image between frames is generated according to a degree of progress of a piece of music played together with a moving image.

6. A moving image generating apparatus comprising:
a storage section which stores in advance a plurality of pieces of movement information showing movements of a plurality of movable points in a predetermined space;
an obtaining section which obtains a still image;
a setting section which sets a plurality of movement control points in each position corresponding to the plurality of movable points in the still image obtained by the obtaining section;
a frame image generating section which moves the plurality of control points based on movements of the plurality of movable points of one piece of movement information specified by a user from among the plurality of pieces of movement information and deforms the still image according to the movements of the control points to generate a plurality of frame images; and
a moving image generating section which generates a moving image from a plurality of frames generated by the frame image generating section.

7. The moving image generating apparatus according to claim 6, wherein:
the movement information is stored corresponded with a model name of a movement model in which the movements of the plurality of movable points are shown successively; and
the frame image generating section moves the plurality of control points based on the movements of the plurality of movable points of movement information corresponded to the model name according to a predetermined operation by a user.

8. The moving image generating apparatus according to claim 6, wherein the movement information includes movement information of moving the plurality of movable points to correspond to a predetermined dance.

9. The moving image generating apparatus according to claim 6, wherein:
the obtaining section obtains a cutout image in which an area including a subject is cutout from an image including a background and the subject as the still image; and
the moving image generating section combines a plurality of frame images generated from the cutout image to another image to generate a moving image.

10. The moving image generating apparatus according to claim 6, wherein the frame image generating section generates an interpolation image between frames according to a degree of progress of a piece of music played together with a moving image.

11. A non-transitory computer-readable storage medium having a program stored thereon for controlling a computer of a moving image generating apparatus including a storage section which stores in advance a plurality of pieces of movement information showing movements of a plurality of movable points in a predetermined space, wherein the program controls the computer to function as:
an obtaining section which obtains a still image;
a setting section which sets a plurality of movement control points in each position corresponding to the plurality of movable points in the still image obtained by the obtaining section;
a frame image generating section which moves the plurality of control points based on movements of the plurality of movable points of one piece of movement information specified by a user from among the plurality of pieces of movement information and deforms the still image according to the movements of the control points to generate a plurality of frame images; and
a moving image generating section which generates a moving image from a plurality of frames generated by the frame image generating section.
